(19) United States
(12) Patent Application Publication
(10) Pub. No.: US 2025/0101792 A1
(43) Pub. Date: Mar. 27, 2025

(54) VOICE ACTIVATED TRUNK, USE OF VOICE TO CONTROL AND CUSTOMIZE CERTAIN VEHICLE FEATURE

(71) Applicant: Panasonic Automotive Systems Company of America, Division of Panasonic Corporation of North America, Peachtree City, GA (US)

(72) Inventor: SAMEH TAWADROUS, SENOIA, GA (US)

(21) Appl. No.: 18/788,208

(22) Filed: Jul. 30, 2024

Related U.S. Application Data
(60) Provisional application No. 63/584,524, filed on Sep. 22, 2023.

(51) Int. Cl. E05F 15/73; B60R 16/037; E05B 81/78; G10L 17/06

(52) U.S. Cl. CPC E05F 15/73; B60R 16/0373; E05B 81/78; E05F 2015/763; E05Y 2900/548; E05Y 2900/55; G10L 17/06

(57) ABSTRACT

A voice control system for a motor vehicle includes a microphone producing a microphone signal dependent upon a voiced utterance by a human user disposed outside of the motor vehicle. An electronic control unit is communicatively coupled to the microphone and recognizes a command in the microphone signal. An application is communicatively coupled to the electronic control unit and receives a signal from the electronic control unit. The electronic control unit implements the command in the microphone signal and thereby modifies a parameter of the motor vehicle.

### CROSS-REFERENCED TO RELATED APPLICATIONS

This application claims benefit of U.S. Provisional Application No. 63/584,524, filed on Sep. 22, 2023, the disclosure of which is hereby incorporated by reference in its entirety for all purposes.

### BACKGROUND OF THE INVENTION

### 1. Field of the Invention.

The present invention relates to identifying human occupants of a motor vehicle and implementing their voice commands.

### 2. Description of the Related Art.

Current lift gate devices on the market require the user to position his leg outside the vehicle so that a sensor can detect the leg.

### SUMMARY OF THE INVENTION

The invention may provide a user access to a vehicle feature by use of a user's voice. A voice-activated feature outside the vehicle may be provided using automatic speech recognition (ASR). Such features may include, but are not limited to, lift gate control, unlocking doors, opening sliding doors, rolling down windows, starting the engine, etc.

Based on Voice Biometrics, additional information can be passed through vehicle infrastructure to vehicle systems to further customize vehicle settings to suit the user at the particular time. Examples may include user seat adjustments and infotainment settings such as saved destinations, song play lists, etc.

User audio intelligence information can be used to determine which vehicle feature to activate. For example, based on the identification of the location of a user based on his voice, it can be determined which door to unlock or which window to open.

In one embodiment, the invention provides a user approaching a vehicle with the ability to control predefined car features such as, trunk opening/closing, window opening/closing, door locks, ignition control, etc. A dedicated light weight, low latency, low current ECU may be utilized. Information gleaned from this interaction with the user may be passed to the main vehicle controller to customize the car experience per the user's preferences, such as seat settings, music play list, HVAC settings, etc.

Based on speaker locations, only certain doors and/or features may be activated. For example, based on audio intelligence, it may be determined that the speaker is on the driver's side, and then only driver-side features are activated.

The invention comprises, in one form thereof, a voice control system for a motor vehicle, including a microphone producing a microphone signal dependent upon a voiced utterance by a human user disposed outside of the motor vehicle. An electronic control unit is communicatively coupled to the microphone and recognizes a command in the microphone signal. An application is communicatively coupled to the electronic control unit and receives a signal from the electronic control unit. The electronic control unit implements the command in the microphone signal and thereby modifies a parameter of the motor vehicle.

The invention comprises, in another form thereof, a voice control system for a motor vehicle having a plurality of doors. The system includes a microphone producing a microphone signal dependent upon a voiced utterance by a human user disposed outside of the motor vehicle. There are means for determining which one of the doors of the motor vehicle the human user is approaching. An electronic control unit is communicatively coupled to the microphone and to the determining means. The electronic control unit recognizes a command in the microphone signal. An application is communicatively coupled to the electronic control unit and receives a signal from the electronic control unit. The application implements the command in the microphone signal to thereby modify the door being approached by the human user.

The invention comprises, in yet another form thereof, a voice biometric system for a motor vehicle. The system includes a microphone producing a microphone signal dependent upon a voiced utterance by a human user disposed outside of the motor vehicle. There are means for determining which one of the doors of the motor vehicle the human user is approaching. An electronic control unit is communicatively coupled to the microphone and performs voice biometric processing on the microphone signal to authenticate the human user. The electronic control unit recognizes a command in the microphone signal. An application is communicatively coupled to the electronic control unit and receives a signal from the electronic control unit indicative of the recognized command. The application implements the command in the microphone signal to thereby modify a first parameter of the motor vehicle. The first parameter is a parameter of the door being approached by the human user. The application receives a user authentication signal from the electronic control unit, and retrieves from memory a preference of the human user who was authenticated by the electronic control unit. The application modifies a second parameter of the motor vehicle dependent upon the preference of the human user that was retrieved from memory.

Advantages of the present invention are that it has many applications and does not require the user to use any limbs.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of a centralized automotive voice biometric ECU arrangement of the present invention.

FIG. 2 is a flow chart of one embodiment of a centralized automotive voice biometric method of the present invention.

FIG. 3 is a flow chart of another embodiment of a centralized automotive voice biometric method of the present invention.

FIG. 4 is a flow chart of yet another embodiment of a centralized automotive voice biometric method of the present invention.

FIG. 5 is a flow chart of still another embodiment of a centralized automotive voice biometric method of the present invention.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

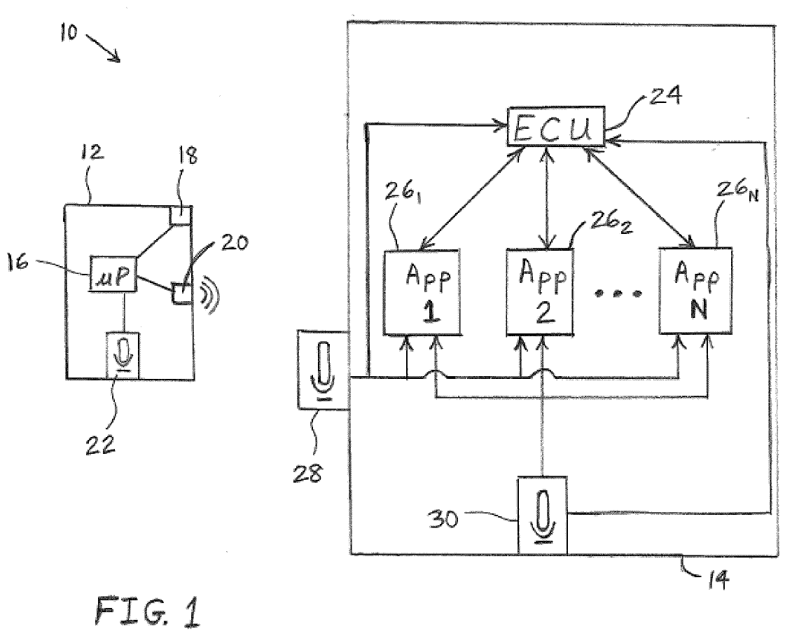

FIG. 1 illustrates one embodiment of a centralized automotive voice biometric ECU arrangement 10 of the present invention, including a key fob 12 and a motor vehicle 14. Key fob 12 includes an electronic processor 16 electrically connected to each of a lock/unlock pushbutton 18, a transponder 20, and a microphone 22.

Vehicle 14 includes a low power, fast booting electronic control unit (ECU) 24 electrically connected to each of N number of applications 26₁, 26₂, . . . , 26_{N} and to both an external microphone 28 and an internal microphone 30. ECU 24 may include an electronic processor and memory. Each of applications 26₁, 26₂, . . . , 26_{N} may include an electronic processor and memory, and may be electrically connected to both external microphone 28 and internal microphone 30. External microphone 28 may be mounted on the exterior of a body of vehicle 14 so that microphone 28 can pick up the voice of a person who is outside of vehicle 14. Internal microphone 30 may be mounted in the passenger compartment of vehicle 14 so that microphone 30 can pick up the voice of a person who is inside vehicle 14. Applications 26₁, 26₂, . . . , 26_{N} may be systems that need a user to be identified by the user's voice, such as, for example, a system that locks and/or unlocks vehicle doors, a system that opens and/or closes vehicle doors, a system that opens and/or closes vehicle windows, a system that turns ON an ignition of vehicle 14, or a system that opens and/or closes a garage door.

During use, vehicle 14 may sense that key fob 12 is nearby or in close proximity (e.g., within ten feet) in any conventional way, such as by use of a key fob proximity sensor. In response to the detecting that key fob 12 is nearby, ECU 24 is booted up such that ECU 24 may quickly access stored voice biometric data and compare a voice signal to the stored voice biometric data.

One of applications 26 and/or ECU 24 may need to verify that a voice signal received from one of microphones 28 or 30 is from the voice of an enrolled or authorized user. The application 26 may transmit the voice signal to ECU 24, and ECU 24 may compare the voice signal to the stored voice biometric data. Alternatively, ECU 24 may receive the voice signal directly from one of the microphones 28 or 30. If a set of the stored voice biometric data associated with a certain enrolled user matches characteristics of the voice signal, then ECU 24 transmits a signal to the application 26 indicating that the voice signal is from the voice of an enrolled or authorized user. However, if none of the sets of the stored voice biometric data associated the respective enrolled users matches characteristics of the voice signal, then ECU 24 transmits a signal to the application 26 indicating that the voice signal is not from the voice of an enrolled or authorized user.

ECU 24 may determine from which enrolled or authorized user the voice signal has been received by one of microphones 28 or 30. ECU 24 may receive the voice signal directly from one of the microphones 28 or 30. If a set of the stored voice biometric data associated with a certain enrolled user matches characteristics of the voice signal, then ECU 24 transmits a signal to the application 26 indicating the identity of the enrolled or authorized user. However, if none of the sets of the stored voice biometric data associated the respective enrolled users matches characteristics of the voice signal, then ECU 24 transmits a signal to the application 26 indicating that the voice signal is not from the voice of an enrolled or authorized user.

In another embodiment, the signal from the key fob that indicates the presence and proximity of the key fob is used by the ECU to identify the person carrying the key fob without any reliance on biometrics verification. Each key fob associated with a vehicle may emit its own characteristic signal, and each key fob may be kept by a particular respective user. If a received key fob signal matches characteristics of the key fob signal associated with an authorized user stored in memory, then the ECU transmits a signal to the application indicating the identity of the enrolled or authorized user. However, if none of the stored characteristics of the key fob signals associated with the respective enrolled users matches characteristics of the key fob signal that is actually received, then the ECU transmits a signal to the application indicating that the key fob signal is not from the key fob of an enrolled or authorized user.

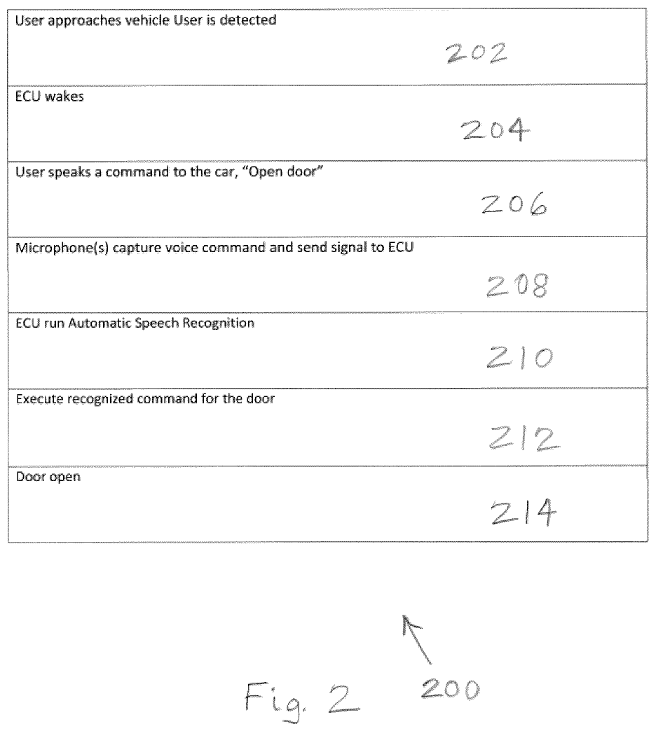

FIG. 2 illustrates one embodiment of a centralized automotive voice biometric method 200 of the present invention. In a first step 202, a user is detected as he approaches a vehicle. For example, the user may be carrying key fob 12, and vehicle 14 may include a key fob proximity sensor that detects when key fob 12 is within a predetermined distance of vehicle 14.

In a next step 204, a voice biometric ECU and/or an automated speech recognition (ASR) ECU awakens. For example, ECU 24 may wake and boot up in response to the user being detected. The ECU may be voice recognition ECU without biometrics.

Next, in step 206, the user speaks a command to the car. For example, the user may say “Open door” to vehicle 14.

In step 208, one or more microphones capture the voice command and send a signal to the voice biometric ECU. For example, before the door is unlocked, microphone 28 may pick up the voice command of the user and send the resulting microphone signal to ECU 24 as well as to applications 26.

In a next step 210, the voice biometric ECU runs automatic speech recognition (ASR) on the signal. For example, ECU 24 may recognize spoken words in the microphone signal and convert the microphone signal into the spoken words. For example, ASR may recognize a spoken command in the microphone signal as “Open door”. The ECU houses and performs automated speech recognition (ASR) and possibly voice biometrics. Thus, the ECU can interpret commands in addition to performing user authentication. It is possible, however, for the ECU to perform voice recognition only.

Next, in step 212, the recognized command is executed. For example, if the spoken command was “Open door,” then voice biometric ECU 24 may send a signal to an application 26 that opens a door of vehicle 14 requesting that the door be opened.

In a final step 214, the door opens. For example, application 26 may cause the door of vehicle 14 to open.

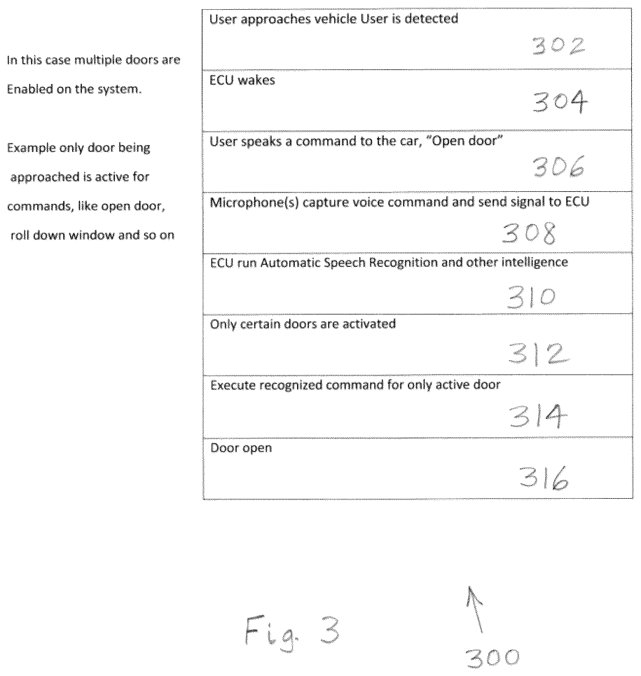

FIG. 3 illustrates another embodiment of a centralized automotive voice biometric method 300 of the present invention. Method 300 is similar to method 200 except that, in method 300, multiple doors are enabled in the system. In the example, however, only the door being approached by the user is active to respond to commands, such as open door, roll down window, etc.

In a first step 302, a user is detected as he approaches a vehicle. For example, the user may be carrying key fob 12, and vehicle 14 may include a key fob proximity sensor that detects when key fob 12 is within a predetermined distance of vehicle 14.

In a next step 304, a voice biometric ECU awakens. For example, ECU 24 may wake and boot up in response to the user being detected.

Next, in step 306, the user speaks a command to the car. For example, the user may say “Open door” to vehicle 14.

In step 308, one or more microphones capture the voice command and send a signal to the voice ASR/biometric ECU. For example, before the door is unlocked, microphone 28 may pick up the voice command of the user and send the resulting microphone signal to ECU 24 as well as to applications 26.

In a next step 310, the voice biometric ECU runs automatic speech recognition (ASR) and other intelligence on the signal. For example, ECU 24 may recognize spoken words in the microphone signal and convert the microphone signal into the spoken words. For example, ASR may recognize a spoken command in the microphone signal as “Open door”. The ECU houses and performs automated speech recognition (ASR) and possibly voice biometrics. Thus, the ECU can interpret commands in addition to performing user authentication.

In addition to recognizing the spoken words, ECU 24 may determine which door the user is approaching, as detected by any of a variety of proximity sensors, such as cameras or infrared sensors that sense the user's body, and/or sensors that detect the location of key fob 12 relative to vehicle 14, or that detect which vehicle door is closest to key fob 12.

Next, in step 312, only certain doors are activated. For example, the vehicle door that the proximity sensor detected that the user was closest to may be the only door that is activated.

In step 314, the recognized command is executed only for the active door. For example, if the spoken command was “Open door,” then voice biometric ECU 24 may send a signal to an application 26 requesting that the sole door of vehicle 14 that was activated in step 312 be opened.

In a final step 316, the door opens. For example, application 26 may cause the door of vehicle 14 that was activated in step 312 to open.

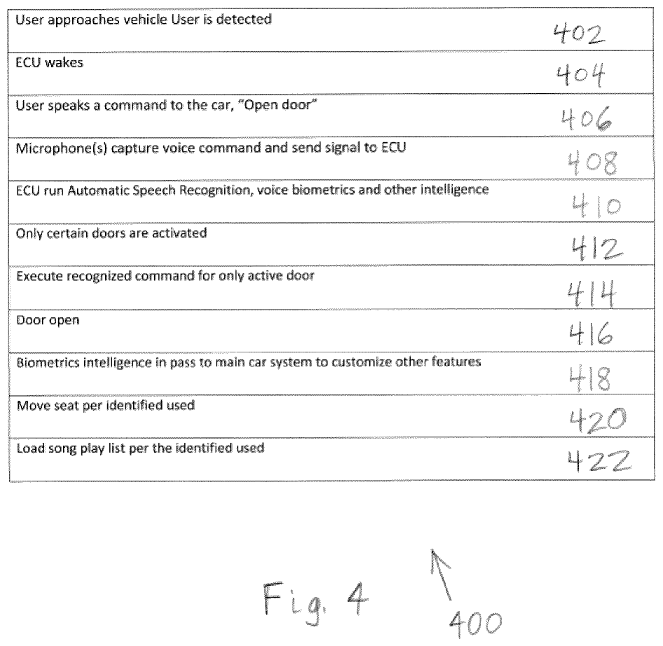

FIG. 4 illustrates another embodiment of a centralized automotive voice biometric method 400 of the present invention. In a first step 402, a user is detected as he approaches a vehicle. For example, the user may be carrying key fob 12, and vehicle 14 may include a key fob proximity sensor that detects when key fob 12 is within a predetermined distance of vehicle 14.

In a next step 404, a voice biometric ECU awakens. For example, ECU 24 may wake and boot up in response to the user being detected.

Next, in step 406, the user speaks a command to the car. For example, the user may say “Open door” to vehicle 14.

In step 408, one or more microphones capture the voice command and send a signal to the voice biometric ECU. For example, before the door is unlocked, microphone 28 may pick up the voice command of the user and send the resulting microphone signal to ECU 24 as well as to applications 26.

In a next step 410, the voice biometric ECU runs automatic speech recognition (ASR), voice biometrics, and other intelligence on the signal. For example, ECU 24 may recognize spoken words in the microphone signal and convert the microphone signal into the spoken words. For example, ASR may recognize a spoken command in the microphone signal as “Open door”. The ECU houses and performs automated speech recognition (ASR) in addition to voice biometrics. Thus, the ECU can interpret commands in addition to performing user authentication.

The voice biometric ECU may also run voice biometric detection on the signal. For example, ECU 24 may compare the microphone signal to sets of stored voice biometric data, with each set of data being associated with a respective enrolled or authorized user.

In addition to recognizing the spoken words and the person who spoke them, ECU 24 may determine which door the user is approaching, as detected by any of a variety of proximity sensors, such as cameras or infrared sensors that sense the user's body, and/or sensors that detect the location of key fob 12 relative to vehicle 14, or that detect which vehicle door is closest to key fob 12.

Next, in step 412, only certain doors are activated. For example, the vehicle door that the proximity sensor or voice intelligence (audio processing) detected that the user was closest to may be the only door that is activated.

In step 414, the recognized command is executed only for the active door. For example, if the spoken command was “Open door,” then voice biometric ECU 24 may send a signal to an application 26 requesting that the sole door of vehicle 14 that was activated in step 412 be opened.

In a next step 416, the door opens. For example, application 26 may cause the door of vehicle 14 that was activated in step 412 to open.

Next, in step 418, biometrics intelligence is passed to the main car system to customize other features. For example, the identified user's preferences as to various settings of the vehicle, such as seat position, mirror position, and music and other infotainment preferences are retrieved from memory and sent to the applications 26 that can implement the preferred settings and thereby customize these features.

In step 420, a seat of the vehicle is moved per the identified user. For example, the identified user's preferences as to seat position, which were retrieved from memory, may be implemented by an application 26.

In a final step 422, a song playlist is loaded per the identified user. For example, the identified user's preferences as to music, which were retrieved from memory, may be implemented by an application 26. Application 26 may create a playlist based on the user's preferences, or application 26 may receive from memory the entire playlist preferred by the user. However application 26 obtains the playlist, application 26 may audibly play the songs on the playlist.

In another alternative embodiment, the ECU contains Bluetooth functionality, enabling users to connect their smart phones to enroll and manage user accounts.

In yet another alternative embodiment, the ECU has a low-power amplifier to enable users to receive audio feedback.

In one alternative embodiment, the ECU has a built-in microphone that can collect audio for voice biometric analysis. Thus, the ECU is not solely dependent on an audio signal being routed to the ECU from an external microphone.

In another alternative embodiment, instead of identifying specific “users”, the ECU tracks only their permission level, informing other systems if the talker is, for example, the owner, a limited user, or unknown.

In another alternative embodiment, the ECU also processes audio to identify different “sounds” for use in emergency vehicle detection.

In another alternative embodiment, the ECU forwards user information to E-Call systems or emergency services to aid in occupant identification.

In another alternative embodiment, the ECU is sent third party enrollment information to confirm the identities of ride-share users.

In another alternative embodiment, the ECU can confirm the occupant identities to federal authorities at Customs and Border stations when the vehicle crosses from one country into another.

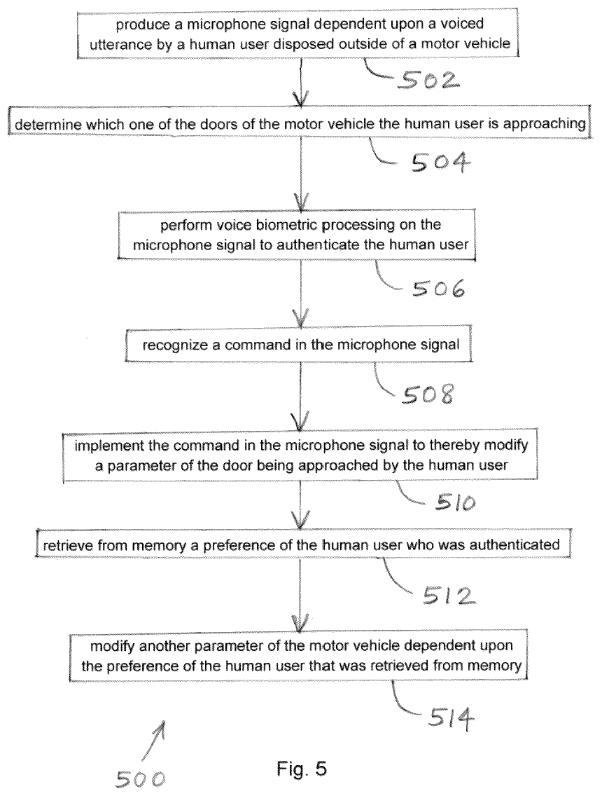

FIG. 5 illustrates still another embodiment of a centralized automotive voice biometric method 500 of the present invention. In a first step 502, a microphone signal is produced dependent upon a voiced utterance by a human user disposed outside of a motor vehicle. For example, microphone 28 can pick up the voice of a person who is outside of vehicle 14 and produce a microphone voice signal based thereon.

In a next step 504, it is determined which one of the doors of the motor vehicle the human user is approaching. For example, ECU 24 may determine which door the user is approaching, as detected by any of a variety of proximity sensors, such as cameras or infrared sensors that sense the user's body, and/or sensors that detect the location of key fob 12 relative to vehicle 14, or that detect which vehicle door is closest to key fob 12.

Next, in step 506, voice biometric processing is performed on the microphone signal to authenticate the human user. For example, microphone 28 may transmit the voice signal to ECU 24, and ECU 24 may compare the voice signal to the stored voice biometric data. If a set of the stored voice biometric data associated with a certain enrolled user matches characteristics of the voice signal, then ECU 24 transmits a signal to an application 26 indicating that the voice signal is from the voice of an enrolled or authorized user.

In step 508, a command in the microphone signal is recognized. For example, ECU 24 may perform automatic speech recognition (ASR) on the microphone signal. ECU 24 may recognize spoken words in the microphone signal and convert the microphone signal into the spoken words. For example, ASR may recognize a spoken command in the microphone signal, such as “Open door”.

In a next step 510, the command in the microphone signal is implemented to thereby modify a parameter of the door being approached by the human user. For example, if the spoken command was “Open door,” then voice biometric ECU 24 may send a signal to an application 26 requesting that the door of vehicle 14 that is being approached by the human user be opened. Application 26 may then cause the door of vehicle 14 that is being approached by the human user to open.

Next, in step 512, a preference of the human user who was authenticated is retrieved from memory. For example, the identified user's preference as to one of various settings of the vehicle, such as seat position, mirror position, and music and other infotainment preferences is retrieved from memory.

In a final step 514, another parameter of the motor vehicle is modified dependent upon the preference of the human user that was retrieved from memory. For example, the identified user's preference as to seat position, which was retrieved from memory, may be implemented by an application 26 to modify the seat position.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A voice control system for a motor vehicle, the system comprising:
a microphone configured to produce a microphone signal dependent upon a voiced utterance by a human user disposed outside of the motor vehicle;
an electronic control unit communicatively coupled to the microphone and configured to recognize a command in the microphone signal; and
an application communicatively coupled to the electronic control unit and configured to:
receive a signal from the electronic control unit; and
implement the command in the microphone signal and thereby modify a parameter of the motor vehicle.

2. The system of claim 1 wherein the microphone is on a key fob.

3. The system of claim 1 wherein the parameter of the motor vehicle comprises a state of a door being open or closed.

4. The system of claim 1 wherein the parameter of the motor vehicle comprises a state of a window being open or closed.

5. The system of claim 1 wherein the microphone is on a body of the motor vehicle.

6. The system of claim 1 wherein the command is a command to turn on an ignition of the motor vehicle.

7. The system of claim 1 wherein the command is a command to open a trunk of the motor vehicle.

8. A voice control system for a motor vehicle having a plurality of doors, the system comprising:
a microphone configured to produce a microphone signal dependent upon a voiced utterance by a human user disposed outside of the motor vehicle;
means for determining which one of the doors of the motor vehicle the human user is approaching;
an electronic control unit communicatively coupled to the microphone and to the determining means, the electronic control unit being configured to recognize a command in the microphone signal; and
an application communicatively coupled to the electronic control unit and configured to:
receive a signal from the electronic control unit; and
implement the command in the microphone signal to thereby modify the door being approached by the human user.

9. The system of claim 8 wherein the determining means comprises a camera or an infrared sensor configured to detect the user's body.

10. The system of claim 8 wherein the determining means comprises a sensor that detects a location of a key fob.

11. The system of claim 8 wherein the command is a command to unlock a door of the motor vehicle.

12. The system of claim 8 wherein the command is a command to open or close a window of the motor vehicle.

13. The system of claim 8 wherein the command is a command to unlock a door and turn on an ignition of the motor vehicle.

14. The system of claim 8 wherein the command is a command to unlock a door and turn on an HVAC system of the motor vehicle.

15. A voice biometric system for a motor vehicle, the system comprising:
a microphone configured to produce a microphone signal dependent upon a voiced utterance by a human user disposed outside of the motor vehicle;
means for determining which one of the doors of the motor vehicle the human user is approaching;
an electronic control unit communicatively coupled to the microphone and configured to:
perform voice biometric processing on the microphone signal to authenticate the human user;
recognize a command in the microphone signal; and
an application communicatively coupled to the electronic control unit and configured to:
receive a signal from the electronic control unit indicative of the recognized command;
implement the command in the microphone signal to thereby modify a first parameter of the motor vehicle, the first parameter being a parameter of the door being approached by the human user;
receive a user authentication signal from the electronic control unit;
retrieve from memory a preference of the human user who was authenticated by the electronic control unit; and
modify a second parameter of the motor vehicle dependent upon the preference of the human user that was retrieved from memory.

16. The system of claim 15 wherein the electronic control unit is configured to perform voice biometric processing on the microphone signal before the motor vehicle is turned on, and before an ignition system of the motor vehicle is turned on.

17. The system of claim 15 wherein the electronic control unit is configured to perform voice biometric processing on the microphone signal before an in-vehicle infotainment system of the motor vehicle is turned on.

18. The system of claim 15 wherein the second parameter of the motor vehicle comprises a scat position.

19. The system of claim 15 wherein the second parameter of the motor vehicle comprises a HVAC system setting.

20. The system of claim 15 wherein the second parameter of the motor vehicle comprises an infotainment system setting.
